(19) United States
(12) Patent Application Publication
(10) Pub. No.: US 2024/0281155 A1
(43) Pub. Date: Aug. 22, 2024

(54) OPTIMIZING A MEMORY SUB-SYSTEM PARTITION CONFIGURATION USING SIMULATION

(71) Applicant: MICRON TECHNOLOGY, INC., Boise, ID (US)

(72) Inventors: Angelo della Monica, Aversa (CE) (IT); Luca Dorato, Volla (IT); Claudio Giaccio, Torre del Greco (IT); Massimo Iaculo, San Marco Evangelista (IT)

(21) Appl. No.: 18/582,525

(22) Filed: Feb. 20, 2024

Related U.S. Application Data
(60) Provisional application No. 63/447,599, filed on Feb. 22, 2023.

(51) Int. Cl. G06F 3/06

(52) U.S. Cl. CPC G06F 3/0625; G06F 3/0659; G06F 3/0679

(57) ABSTRACT

A set of simulations of a function to be performed by a computing system is performed. Each of the set of simulations are performed according to a distinct hardware/software partition configuration for the computing system. One or more outputs of each simulation of the set of simulations are obtained. The one or more outputs of a respective simulation indicate resources consumed by the computing system based on the respective simulation. An optimal hardware/software partition configuration for the computing system is determined based on the obtained one or more outputs of each simulation of the set of simulations. An indication of the determined optimal hardware/software partition configuration is provided to a processing device to cause the processing device to execute one or more operations associated with the function at the computing system in accordance with the optimal hardware/software partition configuration.

### RELATED APPLICATIONS

This application claims the benefit of priority of co-pending U.S. Provisional Application No. 63/447,599, filed Feb. 22, 2023, the entire contents of which are hereby incorporated herein by reference.

Embodiments of the disclosure relate generally to memory sub-systems, and more specifically, relate to optimizing a memory sub-system partition configuration using simulation.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory sub-system, in accordance with some embodiments of the present disclosure.

FIG. 2 illustrates an example manufacturing environment, in accordance with some embodiments of the present disclosure.

FIG. 3 illustrates an example simulation engine, in accordance with some embodiments of the present disclosure.

FIGS. 4A and 4B depict example nodes of a simulation engine, in accordance with some embodiments of the present disclosure.

FIG. 5 is a flow diagram of an example method for optimizing a memory sub-system partition configuration using simulation, in accordance with some embodiments of the present disclosure.

FIG. 6 is a flow diagram of another example method for optimizing a memory sub-system partition configuration using simulation, in accordance with some embodiments of the present disclosure.

FIG. 7 is a block diagram of an example computer system in which embodiments of the present disclosure may operate.

### DETAILED DESCRIPTION

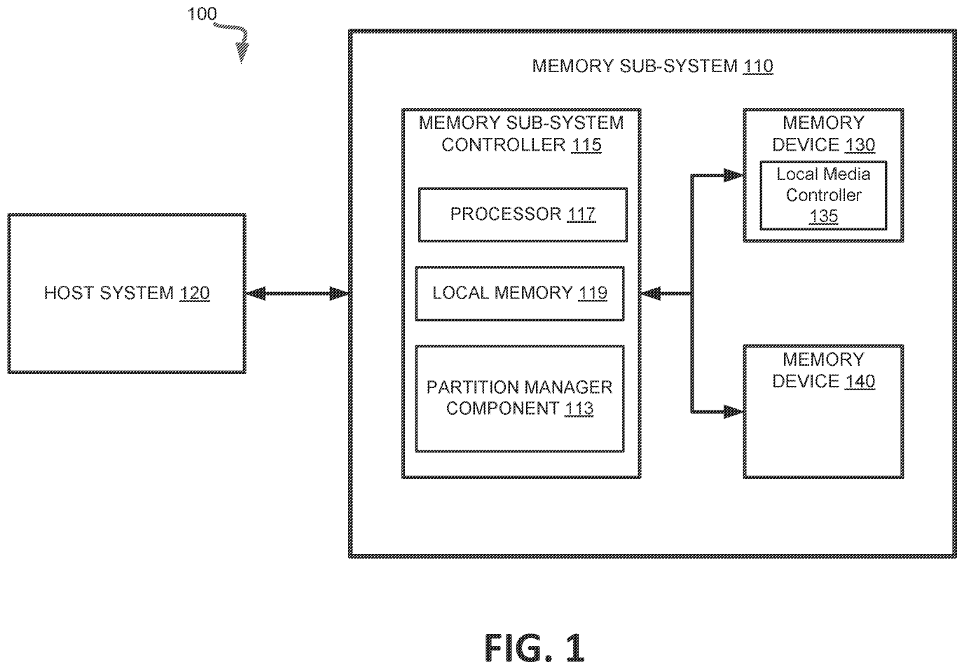

Aspects of the present disclosure are directed to optimizing a memory sub-system partition configuration using simulation. A memory sub-system can be a storage device, a memory module, or a combination of a storage device and memory module. Examples of storage devices and memory modules are described below in conjunction with FIG. 1. In general, a host system can utilize a memory sub-system that includes one or more memory components, such as memory devices that store data. The host system can provide data to be stored at the memory sub-system and can request data to be retrieved from the memory sub-system.

A memory sub-system can utilize one or more memory devices, including any combination of the different types of non-volatile memory devices and/or volatile memory devices, to store the data provided by the host system. In some embodiments, non-volatile memory devices can be provided by negative-and (NAND) type flash memory devices. Other examples of non-volatile memory devices are described below in conjunction with FIG. 1. A non-volatile memory device is a package of one or more dice. Each die can include one or more planes. A plane is a portion of a memory device that includes multiple memory cells. Some memory devices can include two or more planes. For some types of non-volatile memory devices (e.g., NAND devices), each plane includes a set of physical blocks. Each block includes a set of pages. “Block” herein shall refer to a set of contiguous or non-contiguous memory pages. An example of a “block” is an “erasable block,” which is the minimal erasable unit of memory, while “page” is a minimal writable unit of memory. Each page corresponds to a set of memory cells. A memory cell is an electronic circuit that stores information. In some instances, memory cells can be single level cells (SLCs) that are configured to store a single bit of data (e.g., a single data item, etc.). In other instances, memory cells can be configured to store multiple bits of data. For example, memory cells can be multi-level cells (MLCs), triple-level cells (TLCs), or quad-level cells (QLCs) (collectively referred to herein as XLCs or multiple level cells). Each memory cell type can have a different data density, which corresponds to an amount of data (e.g., bits of data, etc.) that can be stored per memory cell).

Data operations can be performed by the memory sub-system. The data operations can be host-initiated operations. For example, the host system can initiate a data operation (e.g., write, read, erase, etc.) on a memory sub-system. The host system can send access requests (e.g., a programming command, a read command, etc.) to the memory sub-system, such as to store data on a memory device at the memory sub-system and to read data from the memory device on the memory sub-system. The data to be read or written, as specified by a host request, is hereinafter referred to as “host data.” A host request can include a logical address (e.g., a logical block address (LBA) and namespace) for the host data, which is the location that the host system associates with the host data. The logical address information (e.g., LBA, namespace) can be part of metadata for the host data. A host data item, as used herein, refers to a unit of host data (e.g., one or more bits of host data) that is associated with a respective logical address (e.g., as provided by the host system).

A memory sub-system controller can execute instructions to perform particular tasks or functions of the memory sub-system, such as communicating with memory devices of the memory sub-system to perform operations such as reading data (e.g., host data), programming data, erasing data, and so forth. Some memory sub-systems (e.g., embedded systems, a system-on-chip (SoC), etc.) can be designed to integrate (e.g., on one chip) general purpose microprocessors, digital signal processors (DSP), programmable logic (e.g., field-programmable gate array (FPGA)), application specific integrated circuit (ASIC) cores, memory block peripherals, interconnection buses, and so forth. Such memory sub-systems can be divided into hardware and software sections where tasks or functions of the memory sub-system can be performed as a series of operations executed via software (e.g., as instructions issued by the memory sub-system controller for execution on a microprocessor, a DSP structure, etc.) or via hardware (e.g., as machine instructions executed on FPGA, ASIC, etc.).

Hardware/software codesign refers to the concurrent design of hardware and software of a computing system, while taking into consideration cost, energy performance, speed, and other conditions of the computing system. Hardware/software partitioning is a part of the codesign process and refers to dividing a system's computations into a portion that executes via software (e.g., as instructions issued by a memory sub-system controller) and another portion that executes via hardware (e.g., as machine instructions executed on FPGA, ASIC, etc.). A system's computations can be partitioned between hardware and software in view of conditions for the system, such as performance, power, size, cost, etc. For example, instructions executed in parallel on an IC fabric can be completed significantly faster (e.g., thousands of times faster) than instructions sequentially executed on a microprocessor. However, executing such instructions on the IC fabric can consume a significantly larger amount of power than executing instructions on the microprocessor. Accordingly, hardware/software partitioning involves determining an optimized configuration for executing instructions (e.g., via hardware and/or via software) in view of design and performance targets for the overall system.

Hardware/software partitioning can be performed (e.g., at the design stage) to identify an optimized hardware/software partition configuration for a memory sub-system during a design phase for the memory sub-system. A hardware/software partition configuration refers to a definition or assignment of particular tasks or functions for performance via software sections and/or via hardware sections of the memory sub-system, as indicated above. An optimal hardware/software partition configuration for a memory sub-system refers to a partition configuration that will cause the memory sub-system to consume a minimal amount of computing resources (e.g., process cycles, power, etc.) while satisfying one or more conditions (e.g., performance conditions) for the memory sub-system. A performance condition includes a condition that the memory sub-system is to satisfy to achieve a target performance. For example, a performance condition can include a condition relating to a minimum number of memory access operations to be performed within a particular time period, a maximum number of errors during performance of memory access operations, etc. A power condition includes a condition of minimal power consumption of the memory sub-system.

Memory sub-systems can be used by host systems with a wide variety of applications and therefore can be subject to different conditions (e.g., performance conditions, power conditions, etc.), depending on host operating requirements. For example, conditions for a memory sub-system used in a cellular telephone can be different from conditions for a memory sub-system used in a surveillance camera in view of different operating requirements of the cellular telephone (e.g., high program performance) and the surveillance camera (e.g., prolonged data retention). Accordingly, an optimized hardware/software partition configuration can differ for memory sub-systems in view of such distinct conditions. Hardware and/or software architecture design can be an early consideration in the development and design of memory sub-systems.

If a memory sub-system controller is configured to execute instructions according to a non-optimized configuration, execution of instructions at the memory sub-system controller can cause excess power consumption, an increased latency of operation performance, a decreased operation throughput, and/or a decreased overall system efficiency. Accordingly, the memory sub-system controller can be configured to execute instructions according to a non-optimized configuration (e.g., identified based on the simulations), which can impact the performance of the memory sub-systems and/or the overall system, as indicated above.

Aspects of the present disclosure address the above and other deficiencies by providing techniques for optimizing a memory sub-system partition configuration using simulation. In some embodiments, a memory sub-system manufacturing environment can include a simulation engine that is configured to perform simulations of operations tasks or functions (e.g., memory access tasks or functions, memory maintenance tasks or functions, etc.) associated with a memory sub-system. The simulation engine can perform such simulations prior to fabrication of the memory sub-system, in some embodiments. As described herein, the simulation engine can include and/or have access to computing resources that are used to simulate executing operations for tasks and/or functions of a memory sub-system. For example, the simulation engine can include computing resources for (or relating to) a microprocessor of a memory sub-system, a DSP structure of a memory sub-system, etc. The simulation engine can use such resources to simulate executing operations for tasks and/or functions of the memory sub-system via software (e.g., as instructions executed by a memory sub-system controller). The simulation engine can additionally or alternatively include computing resources for (or relating to) FPGA, ASIC, etc. The simulation engine can use such resources to simulate executing operations for tasks and/or functions of the memory sub-system via hardware, (e.g., as machine instructions executed by FPGA, ASIC, etc.).

In some embodiments, the simulation engine can include one or more nodes (referred to as simulation nodes herein). Each simulation node can be a component (e.g., a software component, a hardware component, a hybrid component, etc.) configured to simulate performance of operations for a task or function of the memory sub-system using the software-based computing resources (e.g., the microprocessor of the memory sub-system, the DSP structure, etc.) and/or the hardware-based computing resources (e.g., the FPGA, ASIC, etc.) of the simulation engine. The simulation node can simulate performance of the operation by executing instructions associated with the operation according to various hardware/software partition configurations using the software-based computing resources and/or the hardware-based computing resources. For example, a simulation node can execute the instructions of the operation via the software-based computing resources and/or the hardware-based computing resources in accordance with various hardware/software partition configurations and can obtain one or more outputs of the simulation. The one or more obtained outputs can indicate a resource consumption (e.g., a number of processing cycles consumed, an amount of power consumed, etc.) during execution of the operations via the software-based computing resources and/or the hardware-based computing resources. The resource consumption indicated by the one or more outputs of the simulation can correspond to a predicted or expected resource consumption by a memory sub-system that executes the operations according to the various partition configurations, in some embodiments. The indicated resource consumption can additionally or alternatively correspond to a performance of the task or function (e.g., an efficiency or speed or performing the task or function, a number of errors associated with performing the task or function, etc.) by a memory sub-system that executes operations of the task or function according to the various partition configurations.

The simulation node can determine an optimal partition configuration for executing operations of the particular task or function based on the one or more outputs of the simulation. An optimal partition configuration refers to a partition configuration that satisfies one or more conditions (e.g., performance conditions, power conditions, etc.) associated with the memory sub-system. Further details regarding the nodes of the simulation engine, performing a simulation of particular tasks or functions of a memory sub-system, and determining an optimal partition configuration for executing operations of the particular tasks or functions are provided herein.

In an illustrative example, a simulation node of the simulation engine can be configured to simulate performing a direct memory access (DMA) task via software-based computing resources and/or hardware-based computing resources of a memory sub-system. Performing a DMA can involve executing four operations (e.g., a set source operation, a set destination operation, a set transfer operation, and/or a start transfer operation), in some instances. The simulation node can execute the four operations of the DMA using the software-based computing resources and/or the hardware-based computing resources of the simulation engine according to various partition configurations to simulate performance of the DMA operation and can collect resource data associated with executing such operations, as described above. For instance, the simulation node can execute one of the four operations via the software-based computing resources and the other three operations via the hardware-based computing resources and collect resource data associated with executing the operations according to such partition configuration. The simulation node can then execute two of the four operations via the software-based computing resources and the other two operations via the hardware-based computing resources and collect resource data associated with executing the operations according to such partition configuration. Once the simulation node collects resource data associated with executing the operations according to each possible partition configuration, the node can identify, based on the collected resource data, a partition configuration that satisfies the one or more conditions associated with the memory sub-system.

As indicated above, each node of the simulation engine can be configured to simulate a particular task or function of the memory sub-system. The simulation engine may determine the optimal partition configuration associated with tasks or functions simulated by each simulation node of the simulation engine, or a portion of simulation nodes of the simulation engine, in some embodiments. Once the optimal partition configuration(s) are identified, the simulation engine can provide the optimal partition configuration to the memory sub-system. For example, the simulation engine can generate configuration code that indicates the optimal partition configuration for performing one or more tasks or functions at the memory sub-system. The configuration code can indicate one or more tasks or functions associated with the memory sub-system, one or more operations associated with each task or function, and whether such operations are to be executed via hardware or via software of the memory sub-system. The configuration code can be installed at the memory sub-system (e.g., during a fabrication and/or manufacturing process) and the memory sub-system controller can execute operations according to the optimal partition configuration of the configuration code, in accordance with embodiments described herein. In other or similar embodiments, the optimal partition configuration can be determined based on an output of a neural network.

As indicated above, the optimal partition configuration for tasks or functions of a memory sub-system can be determined prior to fabrication or manufacturing of a memory sub-system, in some embodiments. In other or similar embodiments, the optimal partition configuration(s) can be determined during operation of the memory sub-system. For example, during fabrication and/or manufacturing of a memory sub-system (e.g., at a manufacturing environment), a controller for the memory sub-system can be configured to execute operations according to a default partition configuration (e.g., default configuration code can be installed at the memory sub-system, etc.). The default partition configuration can be a non-optimized partition configuration that is applied to each memory sub-system manufactured or fabricated at the manufacturing environment. After power-up of the memory sub-system, the memory sub-system controller can receive requests from a host system to access data at the memory sub-system controller. After some time, the memory sub-system controller can detect a pattern of requests received from the host system. For example, the memory sub-system controller can determine that the host system frequently transmits requests to perform DMA tasks at the memory sub-system. In some embodiments, the memory sub-system controller can cause a simulation node associated with DMA (e.g., of the simulation engine described above) to perform a simulation to identify an optimal partition configuration associated with performing DMA operations at the memory sub-system, as described above. For example, the memory sub-system controller can transmit a request to the simulation engine to perform the simulation and the simulation node can perform the requested simulation, as described herein according to some embodiments. The simulation node can provide an indication of the identified optimal partition configuration to the memory sub-system controller to cause the memory sub-system controller to execute operations for a future DMA request according to the optimal partition configuration, in some embodiments.

Advantages of the present disclosure include, but are not limited to, providing a mechanism to configure a memory sub-system to execute operations according to an optimized hardware/software partition in view of conditions for the memory sub-system. As indicated above, simulation nodes of a simulation engine can identify an optimal partition configuration for executing operations for particular tasks or functions of a memory sub-system. In some embodiments, the simulation engine can determine the optimal partition configuration for each type of task or function expected to be performed at a memory sub-system prior to fabrication or manufacturing of the memory sub-system. The memory sub-system controller can execute instructions according to the optimal partition configuration upon power-up of the memory sub-system, which can decrease the amount of power consumed by the memory sub-system, decrease an operation latency at the memory sub-system, increase an operation throughput at the memory sub-system, and/or increase an overall system efficiency. In some embodiments, the optimal partition configuration can be determined after the memory sub-system is powered up and the host system transmits requests to the memory sub-system, as described above. The optimized partition configuration can be determined in view of conditions corresponding to an actual implementation of the memory sub-system in view of host system requirements, which can further decrease the amount of power consumed by the memory sub-system, decrease an operation latency at the memory sub-system, increase an operation throughput at the memory sub-system, and/or increase an overall system efficiency.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to multiple memory sub-systems 110 of different types. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCle controller, SATA controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCle bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include a negative-and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, PLCs or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, or electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or another suitable processor.

The memory sub-system controller 115 can include a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, memory sub-system 110 is a managed memory device, which is a raw memory device 130 having control logic (e.g., local media controller 135) on the die and a controller (e.g., memory sub-system controller 115) for media management within the same memory device package. An example of a managed memory device is a managed NAND (MNAND) device.

In one embodiment, the memory sub-system 110 includes a partition manager component 113 (referred to as partition manager 113). In some embodiments, the memory sub-system controller 115 includes at least a portion of the partition manager component 113. For example, the memory sub-system controller 115 can include a processor 117 (processing device) configured to execute instructions stored in local memory 119 for performing the operations described herein. In some embodiments, the partition manager component 113 is part of the host system 120, an application, or an operating system.

Partition manager 113 can execute operations at memory sub-system 110 according to a hardware/software partition configuration, in some embodiments. As indicated above, a hardware/software partition configuration (referred to as a partition configuration herein) refers to a definition or assignment of operations for particular tasks or functions associated with memory sub-system 110 for performance via software (e.g., as instructions issued by memory sub-system controller 110) or via hardware (e.g., as machine instructions executed on FPGA, ASIC, etc.). Operations can be defined for execution via software or hardware based on a type of the task or function, a type of the operation corresponding to the task or function, a time associated with performing or executing the task or function, or the operation of the task or function, an entity that executes the operation, and so forth. In an illustrative example, the partition configuration can include an indication of a sequence of operations associated with a particular task or function and, for each operation, a parameter indicating whether the operation is to be executed via hardware (e.g., as machine instructions) or via software (e.g., as instructions issued by memory sub-system controller 115). As described herein, configuring memory sub-system controller 115 to execute instructions according to a particular partition configuration refers to programming configuration code and/or updating settings for memory sub-system controller 115 to cause memory sub-system controller 115 to execute instructions in accordance with a particular partition configuration. In some embodiments, memory sub-system controller 115 can access the partition configuration upon first power up and can apply the partition configuration for each operation performed at memory sub-system 110. In other embodiments, memory sub-system controller 115 can access the partition configuration upon each power up of memory sub-system 110. In yet other or similar embodiments, memory sub-system controller 115 can access the partition configuration in response to receiving a request from host system 120 to perform a particular task or function. For example, in response to receiving a request to perform a direct memory access (DMA) at one or more of memory devices 130, 140, memory sub-system controller can access the configuration code programmed to the memory of memory sub-system 110 and/or settings of memory sub-system controller 115 to determine which operations of the DMA are to be executed via hardware or software.

As indicated above, the partition configuration can provide, for each type of task or function to be performed by memory sub-system 110, an indication of whether operations of the task or function are to be executed via hardware or via software. For example, the partition configuration can indicate that each operation associated with a memory access task or function (e.g., reading data from memory device 130, 140, writing data to memory device 130, 140, etc.) is to be executed via hardware or via software. In another example, the partition configuration can indicate that one or more operations associated with a memory access task or function are to be executed via hardware while other instructions are to be executed via software. In some embodiments, memory sub-system 110 may include a single hardware component (e.g., a FPGA, ASIC, etc.). In such instances, any operations that are designated for execution via hardware can be executed as machine instructions via the single hardware component. In other or similar embodiments, memory sub-system 110 can include multiple hardware components. In such instances, the partition configuration can identify, for each operation designated for execution via hardware, which instructions are to be executed via each of the multiple hardware components.

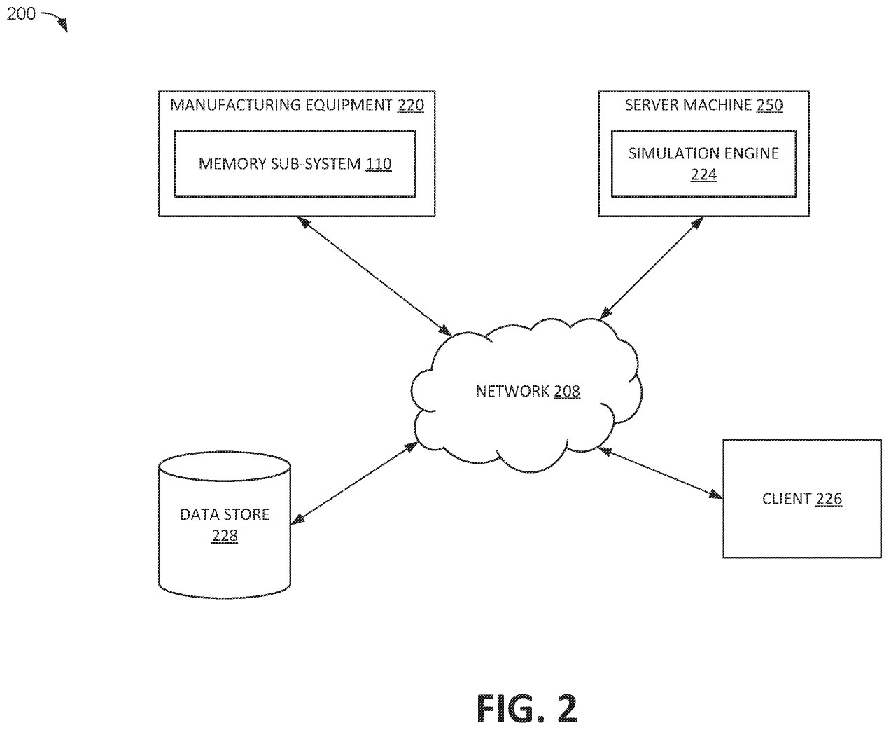

As indicated above, partition manager 113 can execute operations according to an optimal hardware/software partition configuration determined for memory sub-system controller 115. For example, an optimal partition configuration can be determined for memory sub-system 110 by one or more components of a manufacturing environment (e.g., prior to or during fabrication of memory sub-system 110), such as manufacturing environment 200 of FIG. 2. The optimal partition configuration can be determined based on one or more outputs of simulation nodes of a simulation engine, in accordance with embodiments described herein. In other or similar embodiments, the optimal partition configuration can be determined based on one or more outputs of a neural network. One or more components of the manufacturing environment can program configuration code to memory for memory sub-system controller 115 (e.g., local memory 119). The configuration code can cause the memory sub-system controller 115 to execute instructions according to the optimal partition configuration. In other or similar embodiments, the one or more components of the manufacturing environment can update settings for memory sub-system controller 115 to cause memory sub-system controller 115 to execute instructions according to the optimal partition configuration. In response to receiving a request (e.g., from host system 120) to access data at one or more of memory devices 130, 140, partition manager 113 can determine whether operations of a task or a function (e.g., a memory access task or function) associated with the request are to be executed via software or hardware in view of the configuration code and/or settings for memory sub-system controller 115. In an illustrative example, partition manager 113 can access the configuration code programmed to memory of memory sub-system 110, as described above, and can determine, based on the configuration code, which operations are to be executed via software or hardware. Partition manager 113 can cause the operations to be executed in accordance with the determination.

In additional or alternative embodiments, an optimal partition configuration can be determined for performing tasks or functions at memory sub-system 110 after fabrication and/or power up of memory sub-system 110. For example, during design and/or fabrication of memory sub-system controller 115, one or more components of manufacturing environment 200 can configure memory sub-system controller 115 to execute operations according to an initial partition configuration. The initial partition configuration can be an optimal partition configuration as determined by one or more components of environment 200, as described above, or a non-optimized partition configuration determined according to other techniques. Memory sub-system controller 115 can receive requests from host system 120 to access data at one or more of memory devices 130, 140. Partition manager 113 can determine a type of tasks or functions requested by host system 120 based on the received requests and can initiate one or more simulations of the tasks or functions according to various partition configurations. Partition manager 113 can determine an optimal partition configuration based on one or more outputs of the simulations and can update one or more settings associated with memory sub-system controller 115 to cause memory sub-system controller 115 to execute operations for the task or function according to the optimal partition configuration (e.g., when a future request to perform the task or function is received from host system 120). Further details regarding partition manager 113 and partitioning execution of operations at memory sub-system 110 are provided herein.

FIG. 2 illustrates an example manufacturing environment 200, in accordance with some embodiments of the present disclosure. As illustrated in FIG. 2, manufacturing environment 200 (referred to simply as environment 200 herein) can include manufacturing equipment 220, server machine 250, one or more client devices 226, and/or a data store 228 each connected via a network 208. It should be noted that manufacturing environment 200 can include one or more additional components not illustrated in FIG. 2, in accordance with embodiments of the present disclosure.

Client devices 226 can include a computing device such as personal computers (PCs), laptops, mobile phones, smart phones, tablet computers, netbook computers, network connected televisions (“smart TVs”), network-connected media players (e.g., Blu-ray player), a set-top box, over-the-top (OTT) streaming devices, operator boxes, etc. Data store 228 can be a memory (e.g., random access memory), a drive (e.g., a hard drive, a flash drive), a database system, or another type of component or device capable of storing data. Data store 228 can include multiple storage components (e.g., multiple drives or multiple databases) that may span multiple computing devices (e.g., multiple server computers). Network 208 can include one or more wide area networks (WANs), local area networks (LANs), wired networks (e.g., Ethernet network), wireless networks (e.g., an 802.11 network or a Wi-Fi network), cellular networks (e.g., a Long Term Evolution (LTE) network), routers, hubs, switches, server computers, cloud computing networks, and/or a combination thereof.

Manufacturing equipment 220 can include equipment for manufacturing memory sub-system 110. In some embodiments, manufacturing equipment 220 can manufacture memory sub-system 110 according to a process recipe. The process recipe can be provided by an operator and/or engineer of environment 200 (e.g., via a client device 226), in some embodiments. In additional or alternative embodiments, manufacturing equipment 220 can obtain the process recipe for manufacturing memory sub-system 110 at data store 228. As indicated above, a memory sub-system 110 can include hardware and software components. In some embodiments, manufacturing equipment 220 can load and/or install software components on memory sub-system 110 to be executed via memory sub-system controller 115, local media controller 135, and/or other components of memory sub-system 110.

In some embodiments, manufacturing equipment 220 can configure memory sub-system controller 115 to execute operations associated with tasks or functions of memory sub-system 110 (e.g., accessing data at memory devices 130, 140, etc.) according to a particular hardware/software partition configuration by providing configuration code to memory sub-system 110 and/or updating settings associated with memory sub-system controller 115 to cause memory sub-system controller 115 to execute particular operations via software or via hardware. Configuration code can specify a series of tasks or functions and, for each task or function, whether operations of the task or function are to be executed via hardware or via software. The configuration code, when provided to memory sub-system controller 115, can cause memory sub-system controller 115 to execute instructions according to the particular hardware/software partition configuration. Manufacturing equipment 220 can update settings associated with memory sub-system controller 115 by identifying one or more controller settings corresponding to execution of operations at memory sub-system 110 and updating the settings to indicate which operations are to be executed via hardware or via software.

In some embodiments, manufacturing equipment 220 can configure memory sub-system controller 115 to execute operations according to an optimal partition configuration (e.g., determined by simulation engine 224, described herein). In other or similar embodiments, manufacturing equipment 220 can configure memory sub-system controller 115 to execute operations according to a default partition configuration (e.g., provided by an operator and/or developer via client device 226, obtained from data store 228, etc.). After fabrication and/or power up of the memory sub-system 110, partition manager 113 can determine an optimal partition configuration for memory sub-system 110 and can update settings associated with memory sub-system controller 115 to cause memory sub-system controller 115 to execute operations according to the optimal partition configuration, in accordance with embodiments described herein.

As illustrated in FIG. 2, server machine 250 can include a simulation engine 224. An engine refers to hardware (e.g., circuitry, dedicated logic, programmable logic, microcode, a processing device, etc.), software (such as instructions run on a processing device, a general purpose computer system, a dedicated machine, etc.), firmware, microcode, or a combination thereof. Simulation engine 224 can be configured to perform one or more simulations tasks or functions performed at memory sub-system 110. In some embodiments, simulation engine 224 can include or have access to (e.g., via network 108) one or more components (e.g., hardware components, software components, etc.) that correspond to components of memory sub-system 110. For example, simulation engine 224 can include a FPGA component, an ASIC component, etc. that is the same as or similar to a FPGA component, an ASIC component, etc. that is included (or to be included) in memory sub-system 110 (e.g., following fabrication). In another example, simulation engine 224 may have access to another device or system (e.g., via network 208 or another network) that includes a FPGA component, an ASIC component, etc. that is the same as or similar to a FPGA component, an ASIC component, etc. of memory sub-system 110. In other or similar embodiments, simulation engine 224 can include or have access to one or more components that are the same as (or performs the same or similar functions as) memory sub-system controller 115 of memory sub-system 110. The above described components of simulation engine 224 are referred to herein as simulated components (e.g., simulated hardware components, simulated software components, etc.). Simulation engine 224 can run simulations of tasks or functions associated with memory sub-system 110 by executing operations associated with the tasks or functions using the simulated components, in accordance with embodiments described herein.

In additional or alternative embodiments, simulation engine 224 can run simulations using a digital model of memory sub-system 110. The digital model can simulate physical and logical processes that are performed at a physical memory sub-system 110. In some embodiments, the digital model can be a digital twin of memory sub-system 110, which can provide a logical environment that emulates interactions of hardware and/or software components of memory sub-system 110. In some embodiments, simulation engine 224 can be configured to perform a simulation using the digital model to simulate processes of a memory sub-system controller 115 during execution of one or more instructions via software and/or hardware of memory sub-system 110 according to a particular partition configuration. In one example, the digital model of memory sub-system 110 can include a digital representation of components such as a microprocessor, a DSP structure, a FPGA, one or more ASIC cores, etc. at memory sub-system 110. In some embodiments, the digital representation can include a virtual replica of the components that is configured to simulate processes of memory sub-system 110. Simulation engine 224 can execute one or more instructions to cause the digital model to simulate the performance of functions or tasks via hardware and/or software using the digitally represented microprocessor, DSP structure, FPGA, ASIC core(s), in accordance with various partition configurations. Instructions and/or operations of the simulation can be provided by an operator and/or an engineer of environment 200 and/or obtained by simulation engine 224 from data store 228, as described herein. In another example, server machine 250 and/or another computing system that is accessible to simulation engine 224, can include one or more of a microprocessor, a DSP structure, a FPGA, one or more ASIC cores, etc. that are the same or similar to components of memory sub-system 110. Simulation engine 224 can execute one or more instructions of a simulation (e.g., provided by an engineer and/or an operator) via hardware and/or software via the microprocessor, the DSP structure, the FPGA, the one or more ASIC cores, etc. in accordance with various partition configurations, as described above.

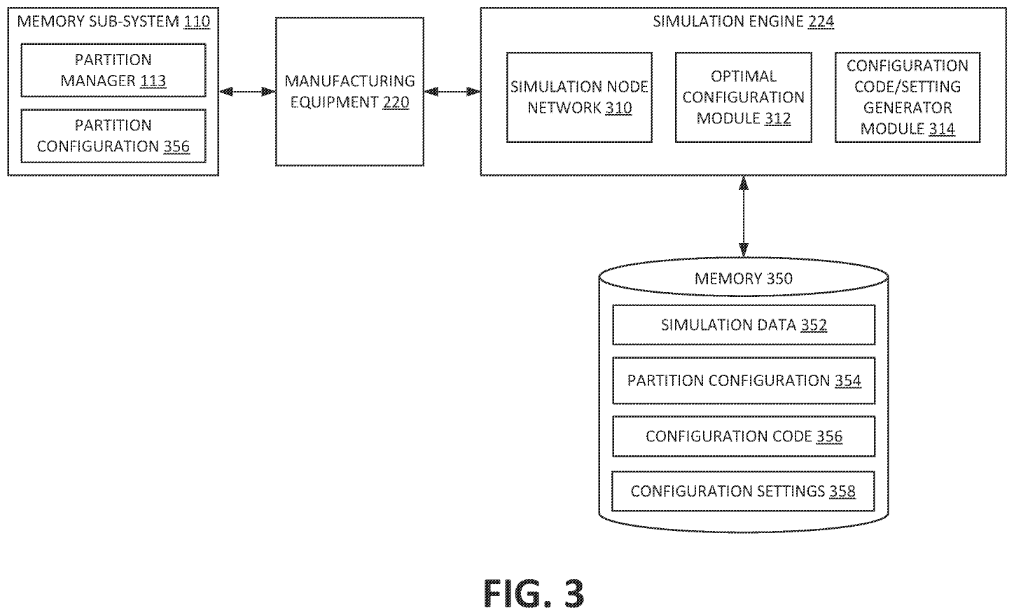

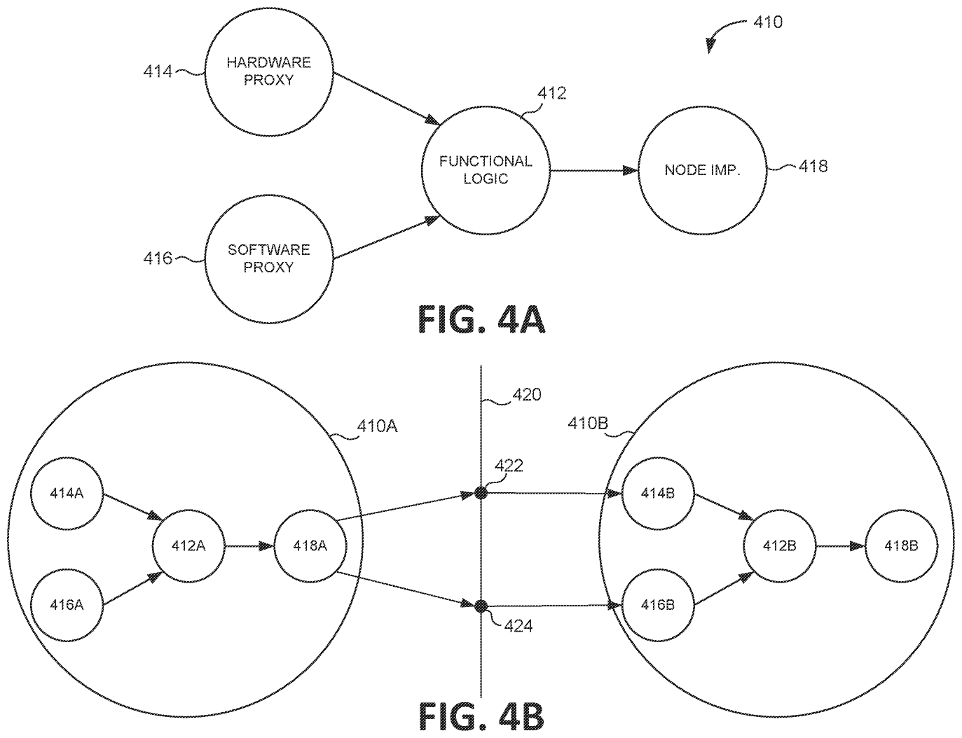

As indicated above, simulation engine 224 can run simulations of tasks or functions associated with a memory sub-system 110. In some embodiments, simulation engine 224 can include one or more nodes (referred to as simulation nodes herein) that are each configured to simulate a particular task or function associated with memory sub-system 110. A node refers to a collection of resources (e.g., software resources, hardware resources) that can execute operations using simulation resources (e.g., simulation components, a digital model, etc.) of simulation engine 224. A simulation node can simulate a particular task or function of memory sub-system 110 by executing operations associated with the particular task or function using the simulation resources. In some embodiments, the simulation node can execute the operations according to multiple different partition configurations. The simulation node (and/or another component of simulation engine 224) can identify a partition configuration that satisfies one or more conditions (e.g., performance conditions, power conditions, etc.) of the memory sub-system 110 as an optimal partition configuration for performing the particular task or function. In an illustrative example, simulation engine 224 can include at least a first node that simulates reading data at a memory sub-system 110, a second node that simulates writing data to memory sub-system 110, a third node that simulates DMA at memory sub-system 110, and so forth. The first, second, and/or third nodes can simulate the tasks or functions according to various partition configurations. An optimal partition configuration for performing such tasks or functions can be determined based on outputs of the simulations, in accordance with embodiments described herein. Further details regarding the simulation nodes of simulation engine 224 are provided with respect to FIGS. 3 and FIGS. 4A-4B.

In some embodiments, simulation engine 224 and/or one or more components of manufacturing equipment 220 can generate configuration code that causes memory sub-system controller 115 to execute operations of tasks or functions at memory sub-system 110 according to a partition configuration. For example, simulation engine 224 can determine an optimal partition configuration for executing tasks or functions associated with memory sub-system 110 based on simulations performed by one or more simulation nodes of simulation engine 224. Simulation engine 224 can generate configuration code that indicates to memory sub-system controller 115 whether operations of the tasks or functions are to be performed via hardware or software at memory sub-system 110, based on the determined optimal partition configuration(s) and provide the generated configuration code to manufacturing equipment 220, in some embodiments. In other or similar embodiments, simulation engine 224 can provide an indication of the optimal partition configuration(s) to one or more components of manufacturing equipment 220. The one or more components of manufacturing equipment 220 can generate the configuration code, in such embodiments. During or following fabrication of memory sub-system 110, manufacturing equipment 220 can store the configuration code at a memory of memory sub-system 110 (e.g., local memory 119), in some embodiments. Memory sub-system controller 115 can access the configuration code after power up and can execute operations associated with tasks or functions of the memory sub-system 110 according to the partition configuration indicated by the configuration code, in some embodiments. In additional or alternative embodiments, manufacturing equipment 220 can update one or more settings of memory sub-system 110 to cause memory sub-system controller 115 to execute operations according to the optimal partition configuration (e.g., after power up).

As indicated above, after fabrication, a memory sub-system 110 (e.g., manufactured at manufacturing environment 200) can be connected to a host system 120. Memory sub-system controller 115 can execute instructions to perform tasks or functions in response to requests from host system 120 (e.g., requests to access data, etc.). In some embodiments, memory sub-system controller 115 can execute the operations via software or via hardware in view of a partition configuration for memory sub-system 110 (e.g., configured by manufacturing equipment 220), as described herein.

FIG. 3 illustrates an example simulation engine 224, in accordance with some embodiments of the present disclosure. As illustrated in FIG. 3, simulation engine 224 can include a simulation node network 310, an optimal configuration module 312, and/or a configuration code/setting generator module 314. Simulation engine 224 can be connected to manufacturing equipment 220 and/or memory 350, in some embodiments. Memory 350 can include one or more regions of data store 228, in some embodiments. In other or similar embodiments, memory 350 can include one or more regions of another memory associated with environment 200 and/or memory sub-system 110. As described above, simulation engine 224 can include one or more nodes that are each configured to simulate a particular task or function of memory sub-system 110. FIGS. 4A and 4B depict example nodes 410 of simulation engine 224, in accordance with some embodiments of the present disclosure.

In some embodiments, each node 410 of simulation engine 224 can correspond to functional logic 412 of a task or function associated with a memory sub-system 110. Functional logic 412 of a task or function refers to one or more operations associated with performing the task or function at memory sub-system 110. In some embodiments, functional logic 412 of node 410 can correspond to accessing data (e.g., reading data, writing data, etc.) at one or more of memory devices 130, 140, or other types of operations associated with memory sub-system 110. In an illustrative example, node 410 can correspond to reading data from one or more memory devices 130, 140 and functional logic 412 of node 410 can correspond to operations associated with reading the data. In another illustrative example, node 410 can correspond to a direct memory access (DMA) (e.g., accessing data programmed to memory without involvement of a processor or a processing device of host system 120) and functional logic 412 can correspond to one or more operations associated with performing the DMA. For purposes of example and illustration only, the operations for a DMA can include a first operation to set an address for a source location for data being accessed (referred to as a set source operation), a second operation to set an address for a destination location for the data being accessed (referred to as a set destination operation), a third operation to set a transfer size for the data being accessed (referred to as a set transfer operation), and a fourth operation to start transfer of the data being accessed, e.g., from the source location to the destination location (referred to as a start transfer operation).

As illustrated in FIG. 4A, node 410 can include one or more proxies. A proxy refers to a component (e.g., a hardware component, a logical component, etc.) that enables node 410 to communicate with other components of simulation engine 224 and/or environment 200. Node 410 can include a hardware proxy 414 and/or a software proxy 416, in some embodiments. Hardware proxy 414 can enable node 410 to access one or more hardware simulation components of simulation engine 224 and/or one or more hardware components of the digital model of memory sub-system 110. Software proxy 416 can enable node 410 to access one or more software simulation components of simulation engine 224 and/or one or more software components of the digital model of memory sub-system 110. In some embodiments, a proxies 414 and/or 416 can establish a connection (e.g., a network connection, etc.) between node 410 and one or more components of simulation engine 224 and/or environment 200. Node 410 can access the components via the established connection to execute operations of an associated task or function of memory sub-system 110, as described herein.

As indicated above, node 410 can simulate particular functions or tasks associated with memory sub-system 110 by executing functional logic 412 of the particular functions or tasks via simulation components of simulation engine 224 according to various partition configurations. In some embodiments, node 410 can execute the functional logic 412 according to each possible partition configuration associated with a particular function or task. For example, as indicated above, functional logic 412 of a DMA task can involve four operations. Node 410 can execute all operations of the functional logic 412 via hardware simulation components of simulation engine 224 (e.g., accessible to node 410 via hardware proxy 414) during a first simulation and can execute all the operations via software simulation components of simulation engine 224 (e.g., accessible to node 410 via software proxy 416) during a second simulation. In additional or alternative embodiments, node 410 can execute some operations of the functional logic 412 via the hardware simulation components and the remaining operations of the functional logic 412 via the software simulation components during one or more simulations.

During each of the simulations, node 410 can receive (e.g., via hardware proxy 414 and/or software proxy 416) data associated with resources consumed during each simulation via the simulation components. For example, node 410 can receive, via hardware proxy 414, data indicating a number of processing cycles consumed, an amount of power consumed, etc. by the simulation hardware components during execution of the operations of functional logic 412 via the hardware simulation components. Node 410 can also receive, via software proxy 416, data indicating a number of processing cycles consumed, an amount of power consumed, etc., by the simulation software components during execution of the operations of functional logic 412 via the software simulation components. The resource data received for each simulation performed via the simulation hardware components and/or the simulation software components can be stored at memory 350 as simulation data 352, in some embodiments.

In some embodiments, node 410 can identify an optimal partition configuration for executing operations of functional logic 412 based on simulation data 352 collected for each of the simulations. As indicated above, an optimal partition configuration refers to a configuration that causes memory sub-system 110 to satisfy one or more conditions (e.g., performance conditions, power conditions, etc.) when memory sub-system controller 115 executes operations of a function or task. In some embodiments, node 410 can determine the optimal partition configuration by identifying, based on simulation data 352, a simulation in which a minimal number of total resources were consumed by simulation hardware components and/or simulation software components and one or more performance criteria were satisfied. A simulation can satisfy performance criteria if the operations were performed within a particular time period (e.g., indicated by a number of processor clock cycles consumed during the simulation) and/or a number of errors that occurred during the simulation falls below a threshold number of errors. The partition configuration that was applied when running the simulation that consumed the minimal number of resources and/or satisfied the performance criteria can be provided as an output 418 of node 410. Accordingly, the provided output 418 can indicate the optimal partition configuration. The output 318 of node 410 can be at memory 350 as partition configuration 354, in some embodiments.

In accordance with the previous illustrative example, functional logic 412 of node 410 can correspond to a DMA involving execution of a set source operation, a set destination operation, a set transfer operation, and a start transfer operation. Node 410 can receive, from hardware proxy 414, a number of process cycles (e.g., clocks) consumed during execution of each of the operations of functional logic 412 via simulation hardware components (e.g., as machine instructions executed via ASIC, FPGA) of simulation engine 224. For instance, hardware proxy 414 can provide a number of process cycles consumed during execution of the set source operation (e.g., approximately 2 clocks), the set destination operation (e.g., approximately 2 clocks), the set transfer operation (e.g., approximately 2 clocks) and/or the start transfer operation (e.g., approximately 2 clocks) via the simulation hardware components. Software proxy 416 can provide a number of process cycles (e.g., clocks) that are consumed during each operation of functional logic 412 via simulation software components (e.g., as instructions executed via a microprocessor). For example, software proxy 416 can provide a number of process cycles consumed during execution of the set source operation (e.g., approximately 20 clocks), the set destination operation (e.g., approximately 10 clocks), the set transfer operation (e.g., approximately 15 clocks) and the start transfer operation (e.g., approximately 50 clocks) via the simulation software components. An output 418 of node 410 can indicate an optimal partition configuration for executing operations of the functional logic 412. In accordance with the previous examples, the output 418 of node 410 can indicate that the optimal partition configuration for executing operations of a DMA is to execute the set source operation, the set destination operation, and the set transfer operation via hardware and the start transfer operation via software.

Referring back to FIG. 3, in some embodiments, each of the one or more nodes of simulation engine 224 can be included in a simulation node network 310. Simulation node network 310 can include nodes that are configured to simulate each task or function that can be performed at memory sub-system 110. In some embodiments, each node 410 of simulation node network 310 can perform simulations of operations of functional logic 412 of the respective node 410, as described above with respect to FIG. 4A. Accordingly, each node 410 can determine an optimal partition configuration for each task or function associated with memory sub-system 110. An output of simulation node network 310 can include partition configuration data that indicates an optimal partition configuration for each task or function associated with memory sub-system 110, in some embodiments. Such output can be stored at memory 350 as partition configuration 354.

FIG. 4B illustrates two example nodes 410 of simulation node network 310, according to embodiments of the present disclosure. As illustrated in FIG. 4B, simulation node network 310 can include at least node 410A and 410B. Node 410A can simulate operations of functional logic 412A by executing the operations at simulation hardware components (e.g., connected to node 410A via hardware proxy 414A) and/or at simulation software components (e.g., connected to node 410A via software proxy 416A). Node 410B can simulate operations of functional logic 412B by executing the operations at simulation hardware components (e.g., connected to node 410B via hardware proxy 414B) and/or at simulation software components (e.g., connected to node 410B via software proxy 416B). In some embodiments, functional logic 412A can correspond to a different task or function of memory sub-system 110 than the task or function of functional logic 412B.

Nodes 410A and 410B can each perform a set of simulations of operations of respective functional logic (e.g., functional logic 412A, functional logic 412B) in accordance with embodiments described with respect to FIG. 4A. As illustrated in FIG. 4B, node 410A can be connected to node 410B of network 310 via a channel 420. Channel 320 can include one or more connection points 422 that enable node 410A to provide an output 418A of node 410A to hardware proxy 414B and one or more connection points 424 that enable node 410A to provide an output 418A of node 410A to software proxy 416B. In some embodiments, network 310 can run one or more simulations in a software environment. In such embodiments, channel 420 between software node 410A and hardware node 410B can include an interconnect software bus (e.g., a software component and/or a software layer that allows nodes 410 to exchange messages). The connection points 422 and/or 424 of physical channel 420 can include software-based connection points that enable interaction between node 410A and node 410B. In other or similar embodiments, network 310 can run one or more simulations in a hybrid environment (e.g., one or more nodes 410 are software-based nodes running in a software environment and one or more other nodes 410 are hardware-based nodes running in a hardware environment). In such embodiments, channel 320 can include any physical structure that allows a message exchange between software and hardware components. For example, channel 320 can include an ethernet channel using transmission control protocol/internet protocol (TCP/IP), a peripheral component interconnect express (PCIe) channel using operating system (OS) drivers, one or more universal asynchronous receiver-transmitter (UART) ports using a serial protocol, and so forth.

In some embodiments, node 410B can perform the set of simulations for the operations of functional logic 412B in view of the output 418A of node 410A. For example, prior to executing the operations of functional logic 412B according to the various partition configurations of the set of simulations by node 410B, node 410B can execute operations of functional logic 412A according to the optical configuration partition identified by output 418A. Once execution of the operations of functional logic 412A is complete, node 410B can execute operations of functional logic 412B according to one or more partition configurations and can determine an optimized partition configuration based on data received from hardware proxy 414B and/or software proxy 416B, as described above. By executing the operations of functional logic 412A prior to executing the operations of functional logic 412B, node 410B is able to identify an optimal partition configuration for functional logic 412B in view of any constraints or impact provided by the identified optimal partition configuration of functional logic 412A. In other or similar embodiments, node 410B may not execute the operations of functional logic 412A prior to executing the operations of functional logic 412B and instead can execute the operations of functional logic 412B according to the various partition configurations, as described above. In response to determining the optimal partition configuration for executing operations of functional logic 412B, node 410B can provide an output 418B of node 410B to another node 410 of simulation node network 310 (e.g., node 410C). In some embodiments, the provided output 418B can indicate the identified optimal partition configuration for executing operations of functional logic 412A and functional logic 412B.

As described above, each node 410 of simulation node network 310 can perform simulations of particular tasks or functions of memory sub-system 110. An output of simulation node network 310 (e.g., provided by a last node 410 of simulation node network 310) can indicate an optimal partition configuration associated with each task or function of memory sub-system 110. In other or similar embodiments, only a portion of nodes 410 of simulation node network 410 can perform simulations of particular tasks or functions of memory sub-system 110. In an illustrative example, simulation engine 224 can identify one or more host usage profiles associated with memory devices 110 fabricated at manufacturing environment 200. A host usage profile can indicate a predicted use of memory sub-system 110 by a host system 120 and/or a type of tasks or functions expected to be performed at the memory sub-system 110 (e.g., following power up of the memory sub-system 110 at the host system 120). In some embodiments, the host usage profiles can be provided by an engineer, developer, or operator of manufacturing environment 200.

Simulation engine 224 can obtain data associated with a particular host usage profile (e.g., from data store 112) and can run simulations to determine an optimal partition configuration for memory sub-system 110 in view of the particular host usage profile. For example, simulation engine 224 can identify one or more types of tasks or functions associated with the particular host usage profile and nodes 410 of simulation node network 310 corresponding to the identified tasks or functions can run simulations to identify the optimal partition configuration for operations of the tasks or functions, as described above. Nodes 410 of network 310 that do not correspond to the identified tasks or functions of the particular host usage profile do not run simulations, in some embodiments. An output of simulation node network 310 can indicate an optimal partition configuration for executing operations of each task or function associated with the particular host usage profile, in accordance with previously described embodiments. Optimal configuration module 312 can store such output at memory 350 as partition configuration 354 with an indication of the particular host usage profile.

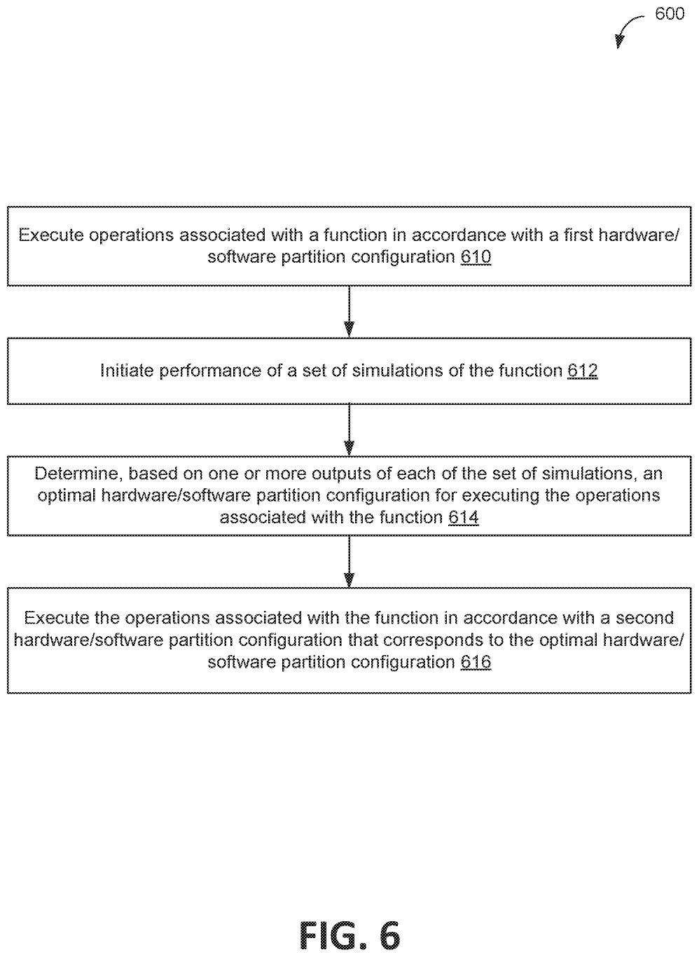

In additional or alternative embodiments, simulation node network 310 can determine an optimal partition configuration based on a type of tasks or functions of requests received by memory sub-system 110 by host system 120. Further details regarding such embodiments are described with respect to FIG. 6 below.

Referring back to FIG. 2, configuration code/setting generator module 314 of simulation engine 224 can generate configuration code 356 and/or determine one or more configuration settings 358 to cause memory sub-system 115 to perform tasks or functions of memory sub-system 110 according to the identified optimal partition configuration (e.g., partition configuration 354). For example, configuration code/setting generator module 314 can generate configuration code 356 that indicates each task or function of partition configuration 354 and, for each task or function, whether operations are to be performed via hardware or software of memory device 110. Configuration code/setting generator module 314 can provide configuration code 356 to manufacturing equipment 220 and manufacturing 220 can install the configuration code 356 at memory sub-system 110, in accordance with previously described embodiments. In other or similar embodiments, configuration code/setting generator module 314 can determine values for one or more configuration settings 358 that will cause memory sub-system controller 115 to execute operations of tasks or functions at memory sub-system 110 according to partition configuration 354. Manufacturing equipment 220 can configure memory sub-system controller 115 to execute the operations according to partition configuration 354 by updating the settings of memory sub-system controller 115 to correspond to configuration settings 358. As indicated above, partition manager 113 of memory sub-system controller 115 to execute operations according to the partition configuration 356 by accessing the configuration code 356 and/or configuration settings 358 and determining whether to execute the operations via hardware or via software.

It should be noted that although embodiments described with respect to FIGS. 3, 4A and 4B are directed to determining an optimal partition configuration for memory sub-systems 110, embodiments of FIGS. 3, 4A and 4B can be applied to other implementations, including implementations where a dynamic of a system cannot be statistically predicted. For example, embodiments described with respect to FIGS. 3, 4A and 4B can be applied to embodiments relating to molecular simulation to identify new materials, hybrid car power balancing between battery and fuel power consumption, patient drug dosage based on pathologies associated with patients, and numerous other implementations.

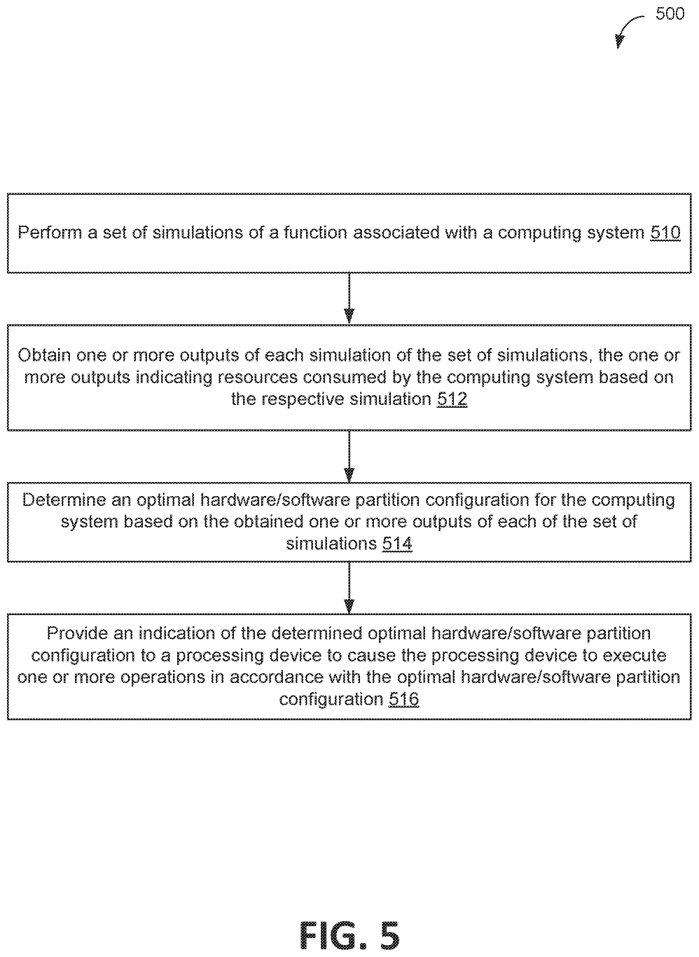

FIG. 5 is a flow diagram of an example method 500 for optimizing a memory sub-system partition configuration using simulation. The method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, one or more operations of method 500 are performed by one or more components of manufacturing environment 200 of FIG. 2. For example, one or more operations of method 500 can be performed by simulation engine 224. In another example, one or more operations of method 500 can be performed by one or more of nodes 410 and/or simulation node network 310, as described with respect to FIGS. 3 and 4A and 4B. In additional or alternative embodiments, one or more operations of method 500 are performed by the memory sub-system controller 115 of FIG. 1. For example, one or more operations of method 500 can be performed by partition manager 113. One or more operations of method 500 is performed by another component of the memory sub-system controller 115, or by a component of local media controller 135, in additional or alternative embodiments.

Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At block 510, processing logic performs a set of simulations of a function (or a task) associated with a computing system. The computing system can correspond to memory sub-system 110. In some embodiments, node 410 and/or simulation node network 310 can perform the simulations in accordance with previously described embodiments. Each of the set of simulations can be performed according to various hardware/software partition configurations, as described above.

At block 512, processing logic obtains one or more outputs of each simulation of the set of simulations. The one or more outputs can indicate resources consumed by the computing system based on the respective simulation. In some embodiments, the one or more outputs for a respective simulation can indicate a number of processor cycles (e.g., clocks) and/or an amount of power consumed by simulation resources (e.g., simulation hardware components, simulation software components, etc.) during the simulation.

At block 514, processing logic determines an optimal hardware/software partition configuration for the computing system based on the obtained one or more outputs of each of the set of simulations. In some embodiments, processing logic (e.g., node 410) can perform simulations according to each possible partition configuration for operations of a task or function of memory sub-system 110. Processing logic can determine the optimal hardware/software partition configuration by identifying the simulation having outputs that indicate a minimal number of resources consumed and/or satisfy performance criteria, as described above. In additional or alternative embodiments, processing logic can determine, after a completion of each simulation, whether outputs of the respective simulation satisfy a one or more resource consumption criteria (e.g., indicate a number of consumed resources that falls below a threshold value) and/or satisfy the performance criteria. If outputs of a respective simulation satisfy the resource consumption criteria and/or satisfy the performance criteria, processing logic can determine that the partition configuration used for the simulation is an optimal partition configuration and processing logic does not perform any additional simulations. If outputs of the respective simulation do not satisfy the resource consumption criteria and/or do not satisfy the performance criteria, processing logic can determine that the partition configuration used for the simulation is not the optimal partition configuration and can continue to perform the simulations until the optimal partition configuration is identified.

In some embodiments, processing logic can determine the optimal hardware/software partition configuration based on an output of a neural network. The neural network can be trained based on historical data collected for prior memory sub-systems initialized at prior host systems. The historical data can include historical operation data indicating one or more operations performed at a prior memory sub-system, historical configuration data (e.g., indicating a hardware/software partition configuration) for the prior memory sub-system, and/or an indication of historical performance metrics (e.g., a number of instructions executed within a time period, an error rate of the instructions executed during the time period, an amount of power consumed by the memory sub-system during the time period, etc.) collected for the prior memory sub-system, in some embodiments. In some embodiments, the machine learning model is a neural network. Upon training, each node of the neural network can correspond to functional logic of a feature or operation of a memory sub-system. An output of each node can indicate an optimal partition configuration for executing instructions of the feature or operation at the memory sub-system, in view of a provided set of conditions.

At block 516, processing logic provides an indication of the determined optimal hardware/software partition configuration to a processing device to cause the processing device to execute one or more operations in accordance with the optimal hardware/software partition configuration. In some embodiments, the processing device can correspond to memory sub-system controller 115. As described above, processing logic (e.g., node 410, simulation node network 310, etc.) can provide an indication of the optimal partition configuration to one or more components of simulation engine 224. The one or more components of simulation engine 224 (e.g., configuration code/setting generator module 314) can generate configuration code 356 and/or determine values for configuration settings 358 to cause memory sub-system controller 115 to perform tasks or functions at memory sub-system according to the optimal partition configuration. Simulation engine 224 and/or manufacturing equipment 220 can provide the configuration code 356 and/or the values of the configuration settings 258 to memory sub-system 110, in accordance with previously described embodiments.

FIG. 6 is a flow diagram of another example method 600 for optimizing a memory sub-system partition configuration using simulation, in accordance with some embodiments of the present disclosure. The method 600 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, one or more operations of method 600 are performed by the memory sub-system controller 115 of FIG. 1. For example, one or more operations of method 600 can be performed by partition manager 113. One or more operations of method 600 can be performed by another component of the memory sub-system controller 115, or by a component of local media controller 135, in additional or alternative embodiments.

Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At block 610, processing logic executes operations associated with a function (or task) in accordance with a first hardware/software partition configuration. In some embodiments, the first hardware/software partition configuration can be a default hardware/software partition configuration that is provided to memory sub-system controller 115 during a fabrication process (e.g., at environment 200). In other or similar embodiments, the first hardware/software partition configuration can be an optimal partition configuration, determined in accordance with embodiments of FIG. 5.

At block 612, processing logic initiates performance of a set of simulations of the function (or task). In some embodiments, one or more nodes 410 of simulation engine 224 and/or one or more portions of simulation node network 310 can reside in or can be otherwise accessible to memory sub-system 110 (e.g., via a network, etc.). In some embodiments, partition manager 113 can transmit a request to simulation engine 224 (e.g., via a network) to run the set of simulations of the task or function. Simulation engine 224 can run the set of simulations in accordance with embodiments of the present disclosure. In additional or alternative embodiments, partition manager 113 can access node 410 (e.g., at memory device 110) to cause node 410 to initiate the set of simulations. Node 410 can perform the set of simulations (e.g., using resources of memory device 110) in accordance with embodiments described above. Partition manager 113 can obtain one or more outputs of the simulation from simulation engine 224 and/or node 410 following completion of the set of simulations.

At block 614, processing logic determines, based on one or more outputs of each of the set of simulations, an optimal hardware/software partition configuration for executing the operations associated with the function. Partition manager 113 can determine the optimal partition configuration in accordance with embodiments described above. For example, partition manager 113 can identify simulation outputs that indicates a minimal amount of resource consumption based on a respective simulation and that one or more performance criteria are satisfied. The partition configuration used for the respective simulation can correspond to the optimal partition configuration. As indicated above, an output of node 410 and/or simulation node network 310 can indicate an optimal partition configuration. Accordingly, partition manager 113 can determine the optimal partition configuration based on the one or more outputs obtained from node 410 and/or simulation node network 310. In additional or alternative embodiments, the optimal hardware/software partition configuration can be determined based on an output of a neural network, as described above.

At block 616, processing logic executes operations associated with the function in accordance with a second hardware/software partition configuration. The second hardware/software partition configuration can correspond to the optimal hardware/software partition configuration determined at block 614. In some embodiments, partition manager 113 can update settings and/or configuration code associated with memory sub-system 110 to cause memory sub-system controller to perform operations of the task or function according to the optimal partition configuration in response to each request to perform the task or function (e.g., received by host system 120).

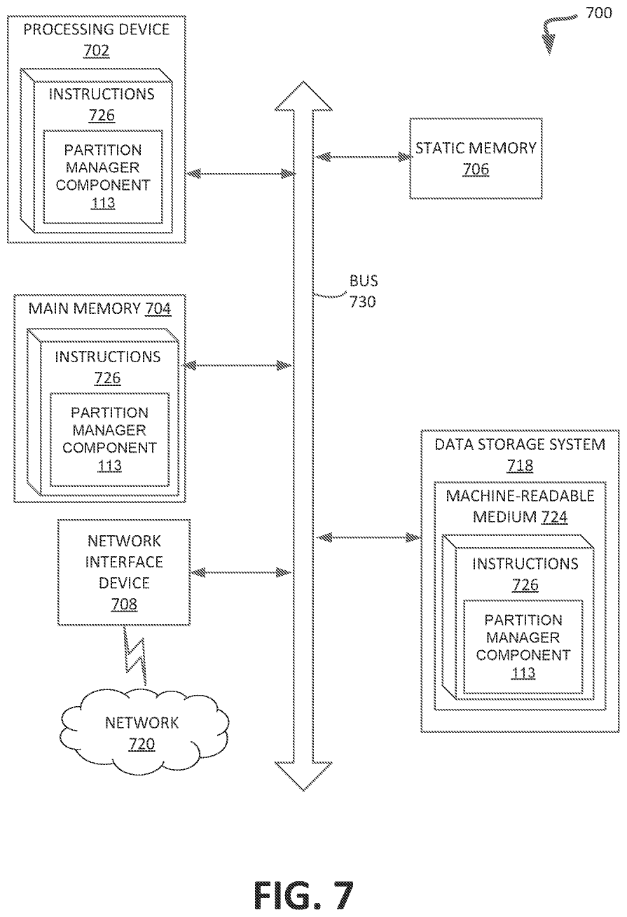

FIG. 7 illustrates an example machine of a computer system 700 within which a set of instructions, for causing the machine to perform any one or more of the methodologies discussed herein, can be executed. In some embodiments, the computer system 700 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the partition manager component 113 of FIG. 1). In other or similar embodiments, computer system 700 can correspond to one or more engines, components, or server machines of FIG. 2. In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 700 includes a processing device 702, a main memory 704 (e.g., read-only memory (ROM), flash memory, dynamic random access memory (DRAM) such as synchronous DRAM (SDRAM) or RDRAM, etc.), a static memory 706 (e.g., flash memory, static random access memory (SRAM), etc.), and a data storage system 718, which communicate with each other via a bus 730.

Processing device 702 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 702 can also be one or more special-purpose processing devices such as an application specific integrated circuit (ASIC), a field programmable gate array (FPGA), a digital signal processor (DSP), network processor, or the like. The processing device 702 is configured to execute instructions 726 for performing the operations and steps discussed herein. The computer system 700 can further include a network interface device 708 to communicate over the network 720.

The data storage system 718 can include a machine-readable storage medium 724 (also known as a computer-readable medium) on which is stored one or more sets of instructions 726 or software embodying any one or more of the methodologies or functions described herein. The instructions 726 can also reside, completely or at least partially, within the main memory 704 and/or within the processing device 702 during execution thereof by the computer system 700, the main memory 704 and the processing device 702 also constituting machine-readable storage media. The machine-readable storage medium 724, data storage system 718, and/or main memory 704 can correspond to memory sub-system 110 of FIG. 1.

In one embodiment, the instructions 726 include instructions to implement functionality corresponding to a partition manager component (e.g., the partition manager component 113 of FIG. 1). In another or similar embodiment, the instructions 726 include instructions to implement functionality corresponding to simulation engine 224. While the machine-readable storage medium 724 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method comprising:
performing, by a simulation engine, a set of simulations of a function to be performed by a computing system, wherein each of the set of simulations are performed according to a distinct hardware/software partition configuration for the computing system;
obtaining one or more outputs of each simulation of the set of simulations, where the one or more outputs of a respective simulation of the set of simulations indicate resources consumed by the computing system based on the respective simulation;
determining an optimal hardware/software partition configuration for the computing system based on the obtained one or more outputs of each simulation of the set of simulations; and
providing an indication of the determined optimal hardware/software partition configuration to a processing device.

2. The method of claim 1, wherein the optimal hardware/software partition configuration for the computing system is determined based on an output of a neural network.

3. The method of claim 1, wherein the set of simulations is performed by a simulation node of a simulation engine, wherein the simulation node is configured to execute one or more operations of the function using one or more computing resources of the computing system according to the distinct hardware/software partition configuration during performance of each of the set of simulations.

4. The method of claim 1, wherein the resources indicated by the one or more outputs of each respective simulation comprises at least one of a number of processor cycles consumed by the computing system during the respective simulation or an amount of power consumed by the computing system during the respective simulation.

5. The method of claim 1, wherein determining the optimal hardware/software partition configuration for the computing system comprises:
identifying a respective simulation of the set of simulations associated with one or more outputs that satisfies a resource consumption criterion; and
determining the respective hardware/software partition configuration used to perform the identified respective simulation, wherein the determined respective hardware/software partition configuration corresponds to the optimal hardware/software partition configuration.

6. The method of claim 5, further comprising:
determining that the one or more outputs associated with the respective simulation satisfies the resource consumption criterion by determining that at least one of a number of processor cycles consumed by the computing system during the respective simulation falls below a threshold number of processor cycles or an amount of power consumed by the computing system during the respective simulation falls below a threshold amount of power.

7. The method of claim 1, wherein providing the indication of the determined optimal hardware/software partition configuration to the processing device comprises:
generating configuration code indicating the function, one or more operations associated with the function, and whether each of the one or more operation are to be executed via software or via hardware at the computing system; and
installing the configuration code at the computing system, wherein the installed configuration code causes the processing device to execute the one or more operations associated with the function in accordance with the optimal hardware/software partition configuration after a power-up of the computing system.

8. The method of claim 1, wherein the computing system comprises a memory sub-system and the processing device comprises a memory sub-system controller.

9. The method of claim 8, wherein the function associated with the computing system corresponds to a memory access operation.

10. A system comprising:
a memory device; and
a processing device coupled to the memory device, the processing device to perform operations comprising:
executing operations of a function in accordance with a first hardware/software partition configuration;
initiating performance of a set of simulations of the function, wherein each of the set of simulations is performed according to one or more distinct hardware/software partition configurations;
determining, based on one or more outputs of each simulation of the set of simulations, an optimal hardware/software partition configuration for executing the operations associated with the function; and
executing the operations associated with the function in accordance with a second hardware/software partition configuration, wherein the second hardware/software partition configuration corresponds to the optimal hardware/software partition configuration.

11. The system of claim 10, wherein determining the optimal hardware/software partition configuration for executing the operations associated with the function is determined based on an output of a neural network.

12. The system of claim 10, wherein initiating performance of the set of simulations of the function comprises:
transmitting a request to a simulation node of a simulation engine for the system to initiate the performance of the set of simulations, wherein the simulation node is configured to execute the operations associated with the function using one or more computing resources of the simulation engine according to the distinct hardware/software partition configuration during performance of each of the set of simulations.

13. The system of claim 10, wherein the one or more outputs of a respective simulation of the set of simulations indicate resources consumed by the system based on the respective simulation, the resources comprising at least one of processor cycles or power resources.

14. The system of claim 10, wherein determining, based on one or more outputs of each simulation of the set of simulations, the optimal hardware/software partition configuration for executing the operations associated with the function comprises:
identifying the respective simulation of the set of simulations associated with one or more outputs that satisfies a resource consumption criterion; and
determining the respective hardware/software partition configuration used to perform the identified respective simulation, wherein the determined respective hardware/software partition configuration corresponds to the optimal hardware/software partition configuration.

15. The system of claim 14, wherein the operations further comprise:
determining that the one or more outputs associated with the respective simulation satisfies the resource consumption criterion by determining that at least one of a number of processor cycles consumed by a computing system during the respective simulation falls below a threshold number of processor cycles or an amount of power consumed by the computing system during the respective simulation falls below a threshold amount of power.

16. The system of claim 10, wherein the processing device comprises a memory sub-system controller.

17. The system of claim 16, wherein the function corresponds to a memory access operation.

18. A non-transitory computer-readable storage medium comprising instructions that, when executed by a processing device, cause the processing device to perform operations comprising:
performing a set of simulations of a function to be performed by a computing system, wherein each of the set of simulations are performed according to a distinct hardware/software partition configuration for the computing system;
obtaining one or more outputs of each simulation of the set of simulations, where the one or more outputs of a respective simulation of the set of simulations indicate resources consumed by the computing system based on the respective simulation;
determining an optimal hardware/software partition configuration for the computing system based on the obtained one or more outputs of each simulation of the set of simulations; and
providing an indication of the determined optimal hardware/software partition configuration to a processing device to cause the processing device to execute one or more operations associated with the function at the computing system in accordance with the optimal hardware/software partition configuration.

19. The non-transitory computer-readable storage medium of claim 18, wherein the optimal hardware/software partition configuration for the computing system is determined based on an output of a neural network.

20. The non-transitory computer-readable storage medium of claim 18, wherein the set of simulations is performed by a simulation node of a simulation engine, wherein the simulation node is configured to execute one or more operations of the function using one or more computing resources of the computing system according to the distinct hardware/software partition configuration during performance of each of the set of simulations.
